(19) United States
(12) Patent Application Publication
(10) Pub. No.: US 2001/0027968 A1
(43) Pub. Date: Oct. 11, 2001

(54) Retractable cauterizing knife

(76) Inventor: Mark Stuart, Prescott, AZ (US)

Correspondence Address: MARK EKDAHL, 316 E. UNION ST., PRESCOTT, AZ, 86301, US

(21) Appl. No.: 09/851,780

(22) Filed: May 10, 2001

Related U.S. Application Data
(60) Provisional application No. 60/179,077, filed on Jan. 31, 2000.

(51) Int. Cl. H05B 1/00

(52) U.S. Cl. 219/233; 219/236; 219/229; 219/240

(57) ABSTRACT

The Retractable Cauterizing Knife is a handyman's tool which combines the utility of a pocket knife with the power of a cautery. It has a cautery filament installed on the cutting edge of the blade with wiring leading through the shaft of the blade to a AA-size battery pack which also serves as the handle of the knife. With just two standard AA-size batteries, the cautery filament can heat to a scorching, red-hot 2,200 degrees Fahrenheit. The cautery can be activated only when the knife is in the extended and locked back position, and a spring-loaded switch is pressed. Therefore, the knife is extremely safe and will not turn on if left alone or dropped. It has unlimited utility, and is particularly valuable for the handyman, cook, and hobbyist.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The retractable cauterizing knife appears to correspond with “Knife—electric or battery driven” (Class D07, Subclass 646) and also with “Knife—additional tool combined” (Class 7, Subclass 151+). It does not, however, seem to correspond with “Cauter—surgical combined” (Class 606, Subclass 44), since it is not intended for any surgical or otherwise professional use.

This invention is intended for the handyman. In the past twenty years, many kinds of knives, multi-tools, and combination knives have been manufactured that are widely useful but lack the element of heat. There have also been many electric cigar lighters made which have no other purpose. The gas-less, battery-driven element of heat in my invention is designed to enable the average individual to confront many disabling situations and materials with a much-needed tool.

In the outdoors, adventure, travel, naturalist, and survival industries, the question of how to start a campfire has lingered between gas, liquid, solid fuel, and stick-rubbing. The cautery in my invention solves this problem with a minimum of danger or environmental harm. The location of the cautery within the blade is safer as opposed to elsewhere, for the person operating it, since there is a natural tendency for an individual to stay clear of a knife, especially if it radiates heat.

In the culinary industry, many chefs could use my invention in order to finish off a cream broullee, finesse an omelet, or effectively complete a preparation of meat, fruit, or vegetable. A cutting edge which lightly singes at the same time is highly desirable in this field. Instead of heating their knives in fire or on a stove, a chef could simply unfold the knife, press the switch, and have the desired result.

People fond of smoking, who are tired of using lighters that are capable of exploding and irritating the fingers, could use my invention to light a cigar or cigarette easily and safely, without the use of butane, which tends to be inhaled and change the flavor of the smoke.

### BRIEF SUMMARY OF THE INVENTION

The retractable cauterizing knife is a tool for the twenty-first century. It combines electrical technology with knife making in a way never before executed. It is widely useful not only in filling gaps in the outdoorsman and culinary industries, but also as a pocket tool with almost as much entertainment value as utilitarian virtue. It is safe and versatile, yet not intended for children under the age of 13. Whether you are on the road, fishing, or at a coffee table, it is the handyman's idol.

### BRIEF DESCRIPTION OF THE SEVERAL VIEWS OF THE DRAWING

FIG. 1 is a frontal view of the invention with the blade extended, in a locked-back position.

FIG. 2 is a sectional view illustrating the electrical wiring of the filament, blade, and blade tang. It also shows the battery case, switch, placement of rivets, locking mechanism, and flange.

### DETAILED DESCRIPTION OF THE INVENTION

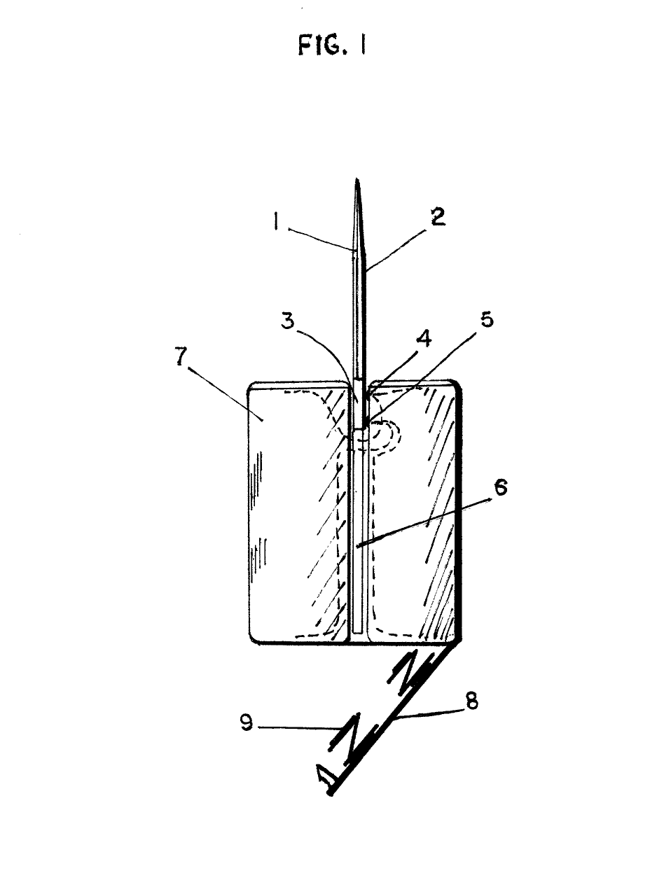

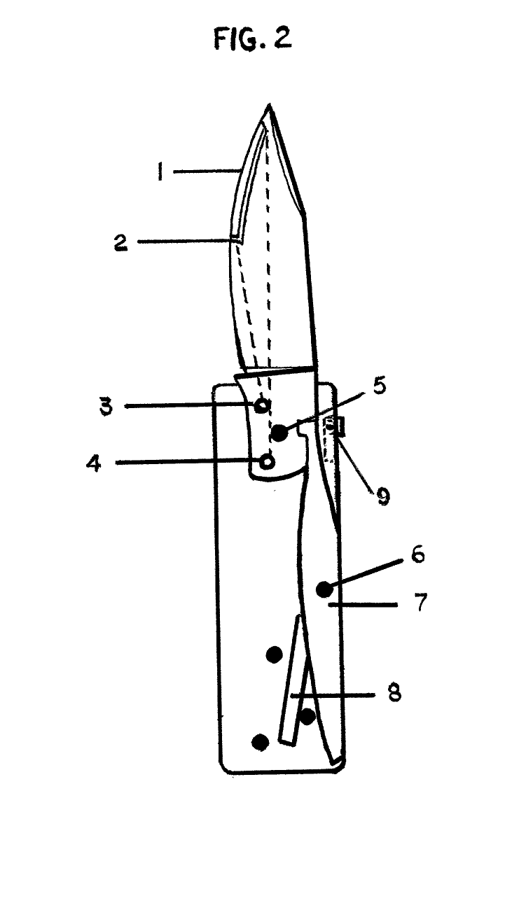

The retractable cauterizing knife is composed of a metallic cautery filament (FIG. 1-1, 2-1) installed in a metallic or ceramic blade (FIG. 1-2). If the blade is metallic, the cautery filament is installed with a ceramic insulator (FIG. 2-2) between itself and the blade. If the blade is ceramic, no ceramic insulator is necessary. Two holes are drilled into the blade from the blade tang end (FIG. 1-3), and are approximately as deep as it takes to reach both ends of the cautery filament. The holes should be big enough to allow small insulated wires to be installed in them. When installed, the filament should run flush on all sides with the blade, and should be designed to be replaceable with either screws or rivets.

At the blade tang, the two insulated wires culminate in two terminals (FIG. 2-3, 2-4) which make contact with two corresponding spring-loaded terminals in the battery case (FIG. 1-7) only when the blade is fully extended and in a locked position. When the blade is in this position, the cautery can be activated by moving a small switch on the exterior of the knife (FIG. 2-9), which will complete the circuit between the batteries and the filament, thus heating the filament.

The battery case should preferably be made of thermoplastics such as Zytel, Kraton, G-10, and Micarta, or from metals alloys of titanium or aluminum The blade should preferably be made of a stainless steel such as ATS-34 or CPM 440V, or of ceramic. The filament should be made of the sturdiest filament material available, and the wiring apparatus (dotted lines) should be flexible and durable. The battery hatch (FIG. 1-8) should be made of the same material as the battery compartment, and the battery springs (FIG. 1-9) should be securely installed on the battery hatch.

The wiring apparatus and switch should be installed in the battery case prior to installing the blade, locking mechanism (FIG. 1-6, 2-6), or flange (FIG. 2-8). Once the knife blade is ready for installation, it can be riveted to the battery case (FIG. 2-5) along with the locking mechanism and flange. (The solid black circles represent rivets). Bolsters on either side of the locking mechanism may be necessary for structural integrity if the battery case is made of thermoplastics.

A wire from each positive battery terminal should join together before reaching the juncture with the tang of the blade (FIG. 1-4). The same should apply to the two wires leading from each negative battery end (FIG. 1-5), so that there is a juncture on only one side of the blade tang. This can be accomplished by running the two wires along the back side of the battery case, behind the locking mechanism, and through to the other side of the blade, without interfering with blade operation. This eliminates redundancy, mechanical weakness, space-wasting, and prevents electrical inefficiency.

The switch should be on the back side of the knife, so that it can be easily manipulated by one's thumb when held in either the left or right hand. The switch should contain a small spring so that the filament may only be activated when the switch is under continuous pressure by the operator of the device. The switch should act upon the positive wiring prior to reaching the blade, so that the batteries cannot ground out through the blade. Each terminal of the battery case should be a waterproof, spring-loaded juncture between the outside and the inside of the battery case, pressing firmly, but not locking, onto the positive and negative terminals of the blade tang.

What I claim as my invention is:

1. An electrically operated knife with electricity running through the blade to a cautery filament installed upon or within the blade.

2. The aforementioned device with a blade of ceramic or metallic material which is capable of being locked and folded.

3. The device described in claim #1 with a battery pack serving as the source of electricity and/or the handle of the knife.
